(19) United States
(12) Patent Application Publication
(10) Pub. No.: US 2013/0319697 A1
(43) Pub. Date: Dec. 5, 2013

(54) LOW-LEAD RESIDENTIAL FIRE PROTECTION SPRINKLERS

(71) Applicants: Oliver S. Pahila, Liberty, SC (US); John Tow, Liberty, SC (US)

(72) Inventors: Oliver S. Pahila, Liberty, SC (US); John Tow, Liberty, SC (US)

(73) Assignee: THE RELIABLE AUTOMATIC SPRINKLER CO., INC., Liberty, SC (US)

(21) Appl. No.: 13/635,314

(22) PCT Filed: Mar. 15, 2011
(86) PCT No.: PCT/US11/28550

§ 371 Date: Nov. 30, 2012

Related U.S. Application Data
(60) Provisional application No. 61/313,987, filed on Mar. 15, 2010.

(51) Int. Cl. A62C 35/68

(52) U.S. Cl. CPC A62C 35/68
USPC 169/37

(57) ABSTRACT

a fire-prevention sprinkler that can be used with a dual-use or multipurpose supply may have a sprinkler body, an inlet to admit water into the sprinkler body and an outlet by which the water can exit the sprinkler body upon actuation of the sprinkler, as well as a deflector to direct the water in a desired pattern as the water exits the sprinkler outlet, and an actuation device, that opens at least the sprinkler outlet upon detection of a fire condition. The entire inner surface of the water passage is made of a material such as will protect the water in the sprinkler from absorbing potentially harmful substances, including as one example lead. The entire sprinkler body may be made of that same substance, as well, and the seal(s) may be made of the same material, or of another having the mentioned property. Such materials are preferably metals, but may be plastic or vitreous.

### RELATED APPLICATION

This application incorporates by reference the entire contents of provisional A.N. 61/313,987, filed Mar. 15, 2010, and claims benefit of the filing date of that provisional application under 35 U.S.C. §119(e).

### BACKGROUND OF THE INVENTION

This application relates to a fire protection method and system, particularly for the protection of residential occupancies, although applicable to other occupancies as well.

In the long history of fire protection technology in the United States, going back to the 1800s, it has been conventional to design and construct fire prevention sprinkler systems that use, as their fire-suppression fluid, water supplied from a pipe system separate from that which supplies drinking water to the occupancy.

Requirements imposed by governmental fire codes and by insurers have long meant that commercial and other public buildings, including large multi-residential occupancies, are normally provided with such a system when first built. With increasing attention being paid to fire safety in the single-family home, however, it would be desirable to find a way to install such a system in single-family residences more easily and at lower cost. If a building's potable-water supply can be used to supply water to the fire-prevention system as well, it is possible to dispense with a large amount of additional piping that would otherwise be required. This has the potential to lower considerably the expense involved in such an installation, especially in a building where space for plumbing is tight.

Moreover, environmental considerations may also lead to a preference for a fire-prevention sprinkler system that can obtain its water from the same interior piping supply as the building's domestic-use water.

With conventional fire-prevention sprinkler systems, however, this is not possible. The reason for this is that the materials conventionally found suitable for use in constructing a fire-prevention sprinkler contain levels of various substances (lead, for example) that preclude the exposure of drinking water to those materials. As one example of a requirement that must be met by a fire-prevention sprinkler that comes into contact with water intended for drinking, such sprinklers must have a lead content of not more than 0.25% by weight. Other examples of the requirements that must be met by a fire-prevention sprinkler that comes into contact with water intended for drinking are that the sprinkler must have a single product allowable concentration (“SPAC”) for lead of less than or equal to 0.5 μg per liter, the total allowable concentration (“TAC”) for lead must be less than or equal to 5 μg per liter (0.5 part per billion), and the lead test statistic Q must be less than 5 μg when normalized for a 1 liter first draw sample, where test statistic Q is defined in accordance with NSF/ANSI 61-2010a Annex F, the contents of which are incorporated herein by reference.

### SUMMARY

To address this problem, therefore, the present invention has been developed with the aim of providing fire-prevention sprinklers that can safely be permitted to come into contact with a supply of drinking water.

The present disclosure, more particularly, provides a fire-prevention sprinkler that can be used with a dual-use or multipurpose supply (that is, where the water in the same interior-piping system is supplied to domestic outlets such as bathroom and kitchen taps, and is acceptable for drinking). Such a sprinkler may, in one embodiment, comprise a sprinkler body, structure defining an inlet to admit water into the sprinkler body and an outlet by which the water can exit the sprinkler body upon actuation of the sprinkler, and a water passage through the body from the inlet to the outlet, as well as a deflector to direct the water in a desired pattern as the water exits the sprinkler outlet, and an actuation device, that opens at least the sprinkler outlet upon detection of a fire condition. The entire inner surface of the water passage is made of a material such as will prevent the release into water in the sprinkler of potentially harmful substances, including as one example lead. The entire sprinkler body may be made of that same material, as well, and the seal(s) may be made of the same material, or of another having the mentioned property. Several examples of sprinkler structures that may embody the present invention are shown and described in the following pages.

It should be noted that the present invention appears to be fully applicable to the construction of sprinklers without any limitation as to the nominal K-factor of the sprinkler, or as to whether the sprinkler is pendent, upright or sidewall type, or as to whether it is designed for use as a control mode sprinkler, a suppression mode sprinkler, or any other type. And while a residential application is particularly contemplated, the invention is believed to be fully applicable to sprinklers for use in other types of occupancies as well.

It should also be noted that while it is most particularly contemplated that the invention will be practiced utilizing a metallic material, particularly an alloy, as the material of the interior of the sprinkler body water passage, it is also within the scope of the invention to utilize other materials that display the requisite chemical stability in terms of not releasing significant amounts of heavy metals or other materials that would be unacceptable in drinking water, into water that contacts the interior of the sprinkler body.

For example, it is also within the scope of the invention to form the sprinkler body out of a plastic material or to make it out of a conventional metal with the entire interior (water-exposed) surface coated with a plastic to prevent the release into the water of any lead or other harmful material present in the metal itself.

Similarly, it is also within the scope of the invention to form the sprinkler body out of a vitreous material or to make it out of a conventional metal with the entire interior (water-exposed) surface coated with such a vitreous material to prevent the release into the water of any lead or other harmful material present in the metal itself.

Additional aspects, objects, features and advantages of the present invention will be more fully appreciated from the following detailed description of certain preferred embodiments, taken in conjunction with the accompanying drawings.

### BRIEF DESCRIPTION OF THE DRAWINGS

FIG. 1 is a side view of a first preferred embodiment of a fire prevention sprinkler.

FIG. 1A is a view from below of the fire prevention sprinkler of FIG. 1.

FIG. 2 is a view partly in section taken from section line 2-2 in FIG. 1.

FIG. 3 is a view like that of FIG. 2 but taken from section line 3-3 in FIG. 2.

FIG. 3A is a detail of a portion of FIG. 3.

FIG. 4 is a view showing the top of one component of a fire prevention sprinkler according to one embodiment.

FIG. 5 is a sectional view, taken from section line 5-5 in FIG. 4.

### DETAILED DESCRIPTION OF THE PREFERRED EMBODIMENTS

Several preferred embodiments of the invention will be described below, with reference to the drawing figures, in which like reference characters denote like elements throughout.

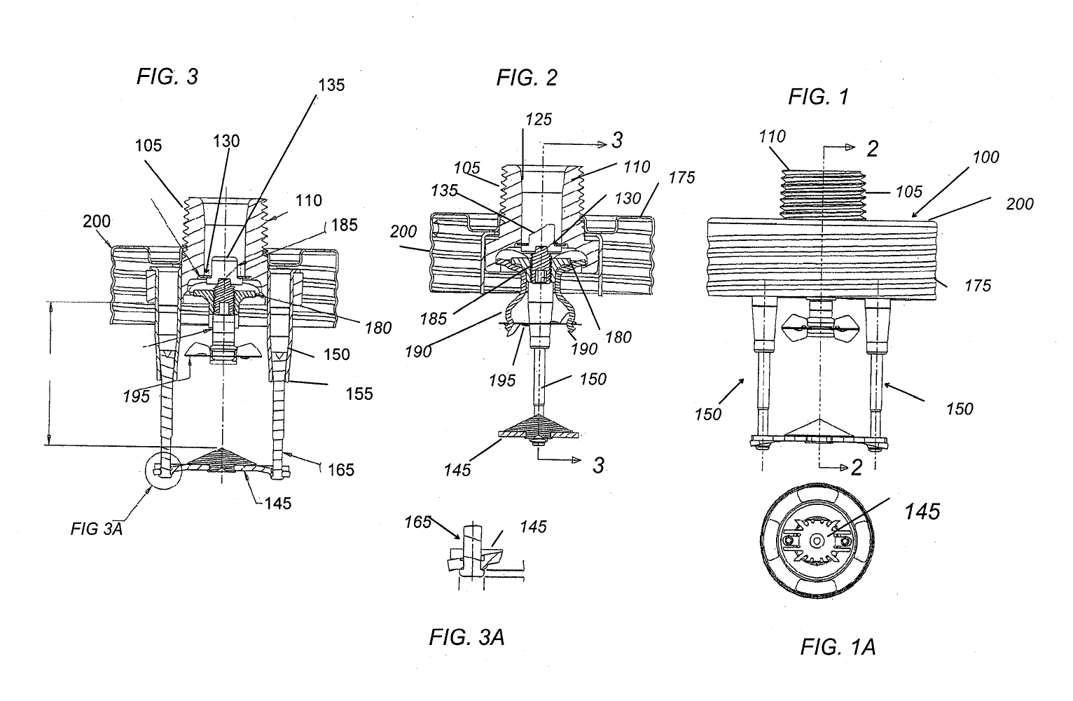

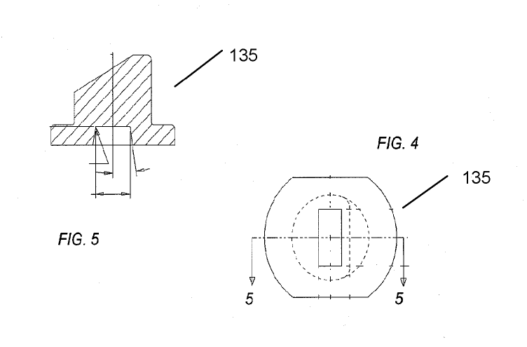

FIGS. 1-3 illustrate a first embodiment of a fire prevention sprinkler 100 suitable for residential installation. The illustrated embodiment is a drop-down pendent sprinkler 100, and is shown in these figures with the deflector in its dropped or extended position, as will be described. The illustrated structure can be applied equally well, however, to pendent or upright, concealed or non-concealed, and horizontal configurations of sprinkler as well.

As shown in FIGS. 1 and 2, a pendent fire protection sprinkler 100 in accordance with the present invention has a body 110 with a threaded base 105 for connection to a conduit (not shown) for supplying pressurized fire-extinguishing fluid, such as water. The body 110 has an axial bore 125 with an outlet orifice 130 from which the fluid is output upon release of a seal cap 135. The output orifice 130 may have a diameter of, for example, ⅜ inch. The sprinkler may have a nominal K-factor of, for example, 4.3, which is defined by K=Q/\sqrt{p}, where Q is the flow rate in gallons per minute and p is the residual pressure at the inlet of the sprinkler in pounds per square inch. As noted, however, the scope of the invention is not limited to this diameter or this K-factor. The body 110 also has a hexagonal flange (not shown) around its output end.

A deflector 145 is coupled to two deflector support members 150 on opposite sides of the sprinkler body 110 (see FIG. 1A for a face-on view of the deflector 145, and FIG. 3A for a detail of the manner in which it is supported by the sprinkler body, described below). Each of the support members 150 includes a housing member 155, which extends downward from the sprinkler body 110, and a rod 165, which is movable with respect to the housing member 155.

For example, the housing member 155 may be a tubular structure positioned within and extending downward from the sprinkler body 110, and the rod 165 may be a solid, generally cylindrical member contained within the housing member 155. However, numerous other configurations for the housing members 155 and rods 165 also are possible. For example, the rods 165 may be tubular members, rather than solid members, and other shapes are possible as well, e.g., square, hexagonal, cylindrical, telescopic, etc. In addition, the housing members 155 may be separate components, as shown, or may be formed unitarily with other portions of the sprinkler body, for example.

During operation, the rods 165 slide from an initial position, in which a large portion of the length of the rod 165 is within the housing member 155 to a deployed position, in which a substantial portion of the length of the rod 165 extends from the bottom of the housing member 155 (as shown in the Figures). Accordingly, in the deployed position, the deflector 145 moves downward along with the rods 165 (see FIG. 2).

The top of the sprinkler body 110 has a threaded portion 175 on its outer surface to allow the sprinkler to be connected to a conduit (not shown) for providing pressurized water to an input end 115 of the fluid passage. (It will be understood of course that the sprinkler can be used with other fire extinguishing fluids, but since it is the purpose to provide a sprinkler that can be used with potable water supply, reference hereinafter will be made only to water as the fluid used.)

The sprinkler body 110 has an outlet 130 that is normally kept closed by a cap assembly that includes a cap 135 and a washer 105 with tape (not illustrated) of a fluoroplastic material such as that sold under the trademark Teflon ® (a registered trademark of the DuPont de Nemours Co.). A yoke 180 and a load screw 185 are positioned below the cap assembly, with the load screw 185 pressing the cap 135 upward into the outlet. Two levers 190 are placed adjacent the yoke 180 and load screw 4, one to each side. Below the outlet 130 the interior of the sprinkler body 110 widens, and a shoulder structure provides a surface on which the upper end of each lever 190 rests. The lower end of each lever 190 resiliently engages a link mechanism 195, which co-operates with the yoke 180 and load screw 185 and the levers 190 to press the cap assembly into place in the orifice 130, preventing water from leaving the orifice until the sprinkler is actuated.

The sprinkler also has a thermally-responsive element (not shown) that holds the seal cap 135 in place over the output orifice. Such elements are well known in the art, and accordingly will not be described in detail. The link 195 may comprise thin metal plates (not shown) of, e.g., beryllium-nickel alloy, overlapping such that openings in each plate receive the lower ends of the levers 190. In such an arrangement, the plates may be attached with solder that melts at a predetermined temperature. The link 195 separates at the predetermined temperature, due to the force applied by the levers 190, allowing the levers 190 to swing outward, releasing the seal cap 135 and allowing the water to be output from the orifice 130. Other types of thermally-responsive elements may be used, including, but not limited to, for example, a frangible bulb and lever assembly, or a sensor, strut, and lever assembly.

More detail on one possible structure and manner of operation of the link 195, levers 190 and thermally responsive element may be found in U.S. Pat. No. 7,275,603, assigned in common herewith, the entire contents of which are incorporated herein by reference.

The sprinkler 100 is mounted in a support cup 200 having a cylindrical, threaded outer wall 175, which surrounds a portion of the installed sprinkler 100 and allows for installation into a ceiling cavity. The support cup 200 also has a mounting platform 210 with a hole in the center into which the sprinkler body 100 is inserted. The hole has a threaded rim portion or tabs configured to interlock with the threads of the sprinkler base.

As shown, the rods 165 of the deflector support members 150, which slide between a position within the housing members 155 and an extended position, each have a frustoconical portion at the top, which forms a small angle with the longitudinal axis of the rod. The frustoconical portion tapers from the top end to the bottom end.

When the sprinkler is deployed (see the Figures), the rod 165 lodges in the housing member 155. By using the above-described configuration, the deflector is more stable when deployed, allowing for a consistent sprinkler spray pattern.

When the sprinkler is installed, water is in contact with a number of surfaces of the sprinkler structure, such as the interior surface of the sprinkler body 125, and the cap 135. Such contact would result in substances contained in the materials of the sprinkler being released into the water. In a sprinkler whose K-factor is 2.8, for example, the surface area in which such contact exists is over 1 square inch, and where the K-factor is 4.4, it may exceed 1.16 square inches, and for larger K-factors, of course, will be still larger. The larger the exposed area is, the greater the likelihood that an unacceptable amount of lead or another harmful substance will be present in the water.

This concern is addressed by manufacturing the surfaces that contact the water supply of a material that will not release problematic amounts of lead or other harmful substances into the water. Examples of materials that have been successfully tested include alloy 2745 and ECO Brass, used for the sprinkler bodies and sealing caps. (For convenience, these and similar materials will be referred to collectively as “low-lead releasing materials”.)

The materials described above results in the release of far smaller quantities of lead and other harmful or possibly harmful substances into the water that the sprinkler comes into contact with. It is noted that other such harmful or possibly harmful materials include antimony, arsenic, beryllium, copper, mercury, thallium, barium and thallium. In fact, it has been found to be possible to reduce the release of such substances in the water with which the sprinkler is in contact to such a point that a standard test of the water for lead (for example) shows the presence of a level lower than 0.25% (weighted average lead content), as required by various standards that will or may come into force in the near future. Several sprinklers made in accordance with the present invention have been subjected to the rigorous testing required of products that will contact drinking water, and have been granted listing by NSF International. In particular, the assignee of the present invention has found that sprinklers having substantially the structure of its existing products RFC49, RFC43 and F1-RES 30, 44, 49 and 58 can successfully be made using such materials, and such have been successfully tested under NSF 61 45 Annex G (this standard encompasses testing for unacceptable or problematic levels of materials other than lead, including those listed above, in this paragraph).

It is preferred to make the relevant parts of the sprinkler of one of the alloys identified above, as doing so permits those parts to be manufactured using techniques not very different from those used in manufacturing conventional sprinklers, thus permitting the manufacture of a low-lead sprinkler without an unreasonably high cost. Other materials can be used, however. As one example, the surfaces that will contact the water may be coated with a layer of a polymeric material (PTFE and FEP for example), formed by deposition on the surfaces of the water passage in the sprinkler body and the sealing cap, or those parts may be made entirely of a polymeric material. Again, those parts may be made of a vitreous material, or coated with a vitreous material. As another example, those parts may be made of metals or alloys that are otherwise desirable for use in view of their strength, reliability, low cost, or other properties, with a coating of one of the above alloys applied to the surfaces that will contact the water supply.

While the present invention has been described with respect to what are presently considered to be the preferred embodiments, it is to be understood that the invention is not limited to the disclosed embodiments. To the contrary, the invention is intended to cover various modifications and equivalent arrangements included within the spirit and scope of the appended claims.

What is claimed is:

1. A fire protection sprinkler, comprising:
a body having a water passage defined therein, the water passage including an inlet orifice and an outlet orifice, and said water passage having its interior surface formed of a low-lead releasing material;
a seal cap to seal a flow of fluid from the output orifice, water-exposed surfaces of said seal cap being formed of a low-lead releasing material;
a thermally-responsive element positioned to releasably retain the seal cap; and
a deflector supported on said body.

2. The fire protection sprinkler of claim 1, wherein the low-lead releasing material is alloy 2745.

3. The fire protection sprinkler of claim 1, wherein the low-lead releasing material is ECO brass.

4. The fire protection sprinkler of claim 2, wherein only said surfaces of said water passage and of said seal cap are made of alloy 2745.

5. The fire protection sprinkler of claim 3, wherein only said surfaces of said water passage and of said seal cap are made of ECO brass.

6. The fire protection sprinkler of claim 2, wherein all of said body is made of alloy 2745.

7. The fire protection sprinkler of claim 3, wherein all of said body is made of ECO brass.

8. The fire protection sprinkler of claim 2, wherein all of said seal cap is made of alloy 2745.

9. The fire protection sprinkler of claim 3, wherein all of said seal cap is made of ECO brass.

10. The fire protection sprinkler of claim 1, wherein said fire protection sprinkler is a residential fire protection sprinkler.

11. The fire protection sprinkler of claim 1, wherein said fire protection sprinkler has a K-factor in a range from 2.8 to 5.8, inclusive.

12. The fire protection sprinkler of claim 1, wherein the low-lead releasing material is a polymeric material.
